(19) United States
(12) Patent Application Publication
(10) Pub. No.: US 2006/0129533 A1
(43) Pub. Date: Jun. 15, 2006

(54) Personalized web search method

(75) Inventor: Lisa S. Purvis, Fairport, NY (US)

Correspondence Address: PATENT DOCUMENTATION CENTER, XEROX CORPORATION, 100 CLINTON AVE., SOUTH, XEROX SQUARE, 20TH FLOOR, ROCHESTER, NY, 14644, US

(73) Assignee: Xerox Corporation

(21) Appl. No.: 11/012,650

(22) Filed: Dec. 15, 2004

(51) Int. Cl. G06F 17/30

(52) U.S. Cl. 707/3

(57) ABSTRACT

A method for contextualizing search results is disclosed. The method includes performing a traditional web query that returns a set of result pages, using collaborative filtering techniques to generate a set of predicted pages, comparing the set of predicted pages with the set of result pages, and ranking the set of result pages so that result pages that are also included in the set of predicted pages are ranked higher than those that are not. Methods herein also contemplate using the search history of the user or others to refine the results of searches.

The embodiments disclosed herein are directed to search engines and more specifically, to methods for optimizing search results.

Current web search engines are good at returning long lists of relevant documents for many user queries, and new methods are improving the ranking of search results. As the web becomes more pervasive, people with different knowledge, backgrounds, and expectations are searching the web. However, the results for a given query are usually identical and independent of the user or the context in which the user made the request. The accuracy of the results usually depends upon the logic structure of the search request and the choice of keywords by the user. Also, web search engines generally treat search requests in isolation. There is currently little work on personalizing web search results based on the user's context, interests, and previous experience.

Some search engines do try to guess the context of user queries, and provide results that match the guessed context. For instance, the search engines Excite (www.excite.com), Lycos (www.lycos.com), Google (www.google.com), and Yahoo (www.yahoo.com) provide special functionality for certain kinds of queries. For example, queries that match the name of a company produce additional results that link directly to company information. Google identifies queries that look like a U.S. street address, and provides direct links to maps. Rather than requiring the user to explicitly enter context information such as “I'm looking for a street address” or “I want a stock quote,” this technique guesses when such contexts might be relevant. This technique is limited to cases where potential contexts can be identified based on the keyword query.

It would be advantageous to provide the user with results based upon the user's web viewing history, and/or the viewing history of others whose page viewing patterns are similar to the user's.

One method for improving search results is to incorporate collaborative filtering techniques to revise the results from a standard search. Collaborative filtering techniques are used in recommendation systems, to recommend products a user might like (e.g. films, books, music, etc.). These techniques have even been used in recommendation systems that suggest hyperlinks that a user might like to visit on his next visit to the web (WebWatcher) [Joachims, T., Freitag, D. and Mitchell, T. “WebWatcher: A tour guide for the World Wide Web,” in Proceedings of the 15th International Joint Conference on Artificial Intelligence, 1997]. These prediction approaches have also been applied in order to cache and prefetch web pages based on users' previous requests, in order to reduce latency and network load.

The embodiments disclosed herein use techniques developed for collaborative filtering/recommendation systems to personalize web searches. As such, they use cases created from web logs that record user sessions to identify which pages from a search result to rank highest, and also provide an ability to add predicted pages to a search result.

Embodiments include a method for contextualizing search results. The method includes performing a traditional web query that returns a set of result pages, using collaborative filtering techniques to generate a set of predicted pages, comparing the set of predicted pages with the set of result pages, and ranking the set of result pages so that result pages that are also included in the set of predicted pages are ranked higher than those that are not.

Embodiments also include a method for personalizing a web search that includes retaining a record of a user's search history, and adjusting the results of the web search by the user's search history.

Various exemplary embodiments will be described in detail, with reference to the following figures, wherein:

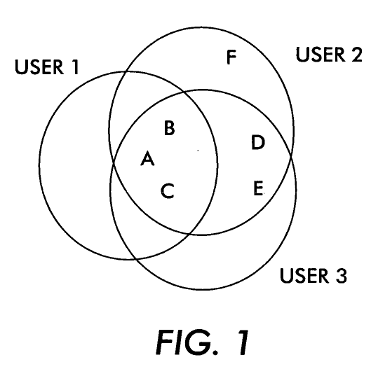

FIG. 1 shows a Venn diagram sowing the interests of three users.

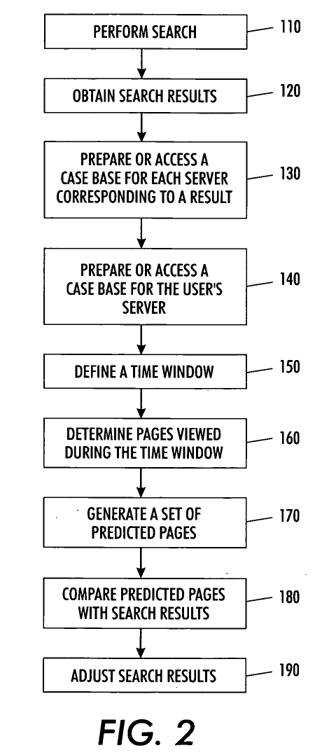

FIG. 2 is a flow chart illustrating methods disclosed herein.

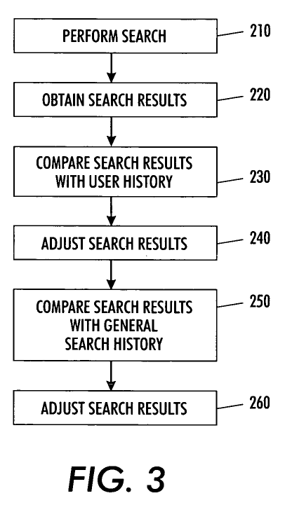

FIG. 3 is a flow chart illustrating methods disclosed herein.

Embodiments disclosed herein provide a method to return personalized results for web queries.

Current state of the art for web search engines is to return the same results for a given query, independent of the user, or the context in which the user made the request. Traditional web queries are usually simple keyword matchings; the more a search term appears on a page (or sometimes in its metacontent), the higher up on the results list that page appears. Some search engines apply other weight factors, such as analyzing the key words for context and by offering the user a chance to specify a subset of the results (e.g., by offering the ability to request “more like this” after a result.) However, they do not personalize the search results; personalized results is used to mean user contextualized results; specifically, results that are based upon the user's web history.

Methods disclosed herein apply the prediction/recommendation approach of collaborative filtering to personalize the results of a web search. Collaborative filtering is a “representation-less” recommendation process, because recommendations can be produced without needing representations of the assets being recommended.

FIG. 1 can be used to show how collaborative filtering works. All three users in FIG. 1 have shown an interest in assets A, B, and C. This high level of overlap indicates that these users have similar tastes. Therefore, it seems a safe bet to recommend assets D and E to User 1 because assets D and E are endorsed by Users 2 and 3. It is also likely to be safe to recommend asset F to User 3 as User 2 and User 3 have A, B, C, D, and, E in common. Web shopping centers such as Amazon.com use such or similar techniques to recommend products to consumers using their sites.

Viewing FIG. 1 in a web searching context, all three users view pages A, B, and C and Users 2 and 3 also view web pages D and E. Because of the high overlap between the pages viewed by User 1 and Users 2 and 3, it may be logical to include, rank, or highlight pages D and E to User 1. For example, were these two web pages to show up as search results, they could be, for example, ranked higher or highlighted in the results.

An exemplary method for incorporating collaborative filtering techniques into web searches includes using case-based analysis of web pages. Case-based Reasoning is commonly known in the art and descriptions of techniques can be found in, for example, “Mining High Quality Cases for Hypertext Prediction and Prefetching,” by Q. Yang, I. Tian-Yi Li, and H. Zhang in Proceedings of the 4th International Conference on Case-Based Reasoning, 2001. On the web, millions of users visit thousands of servers, leaving rich traces of document retrieval, problem solving, and data access. Thus, the hypertext retrieval on the Web can be used as an experience base for personalizing a web search. A web log can be mined for cases that can then later be used for prediction.

For example, a user may visit several pages A, B, C, and D while connected to the web. The user then uses a search engine to locate web pages of interest. The search engine generates a list of web pages in response to the user's query.

For each page in the query results, the search engine would obtain a “case base” for the server log from which that query result came. Obtaining a case base means either generating a new case base or accessing a previously created case base. The paper by Yang, Li, and Zhang referenced above describes how such a case base can be generated with accuracy. Embodiments disclosed herein use the cases prepared in such a manner in order to help personalize a web search. For example, the search may return page R1, which comes from server S1. The search engine software would retrieve S1's access log and either create a case base or access a previously created case base for this log, which will produce a set of predictions. The case base would include information on which pages had been viewed on the server and, more specifically, which pages had been viewed by the same entity. This would allow the determination of probabilities for selecting predicted pages. For example, it may be that people who viewed pages E and F were likely to view page G.

Alternatively or additionally, a case base may also be prepared for the user's web server. Instead of being based upon pages accessing the web through the user's web server, the case base would be based upon pages that were viewed through the user's web server. This could be advantageous where, for example, where the user's web server is a company web server. It may be likely that people from the same company would have similar interests or overlap in some areas. A software company may have employees visiting common vendor and information sites.

Next a “time window” for the current user is determined. The time window is used to determine how many pages viewed by the user should be included in the predictive model. This can be based upon an actual number of previously viewed pages (e.g., 5, 10, etc.) or it could be based upon the pages viewed by the user in a previous amount of objective time (e.g., 0.5 hr, 2 hrs, etc.). The web sequence viewed during this time window would be recorded (e.g. this user accessed pages A, B, C, and D during the time window). The choice of time window may be static, or it may be a selectable feature of the search engine. The time window may also be selectable by the user, and be included, for example, with advanced search options. The time window could also be longer than the user's current session. However, this option would require that the user's web history data from previous times online be stored. This information could be stored, for example, on the server or locally at the user's personal computer. This data could be stored in a variety of ways such as, for example, in a cookie file on the user's personal computer.

Next cross-reference the sequence viewed during the time window with the case bases made for the server logs of the search results to determine predicted pages. For example, say the user visited pages A, B, C, and D during the time window, check to see whether any of these pages are part of the case base for the server S1, from which the first search result page R1 comes. If pages A, B, C, and D were all connected to the web through server S1 and the sequence ABCD were part of the case base of the server S1, page E may be identified by the server as a prediction because users who viewed ABCD, also viewed page E. If the server only hosted pages A and B, the case base would produce a predicted page or pages based upon what viewers of pages A and B also viewed (for example, pages E and F).

For the case base of the user's server, the case base would be of pages that were pulled by the server and not pages accessing the web through the server. Therefore, where a case base of the user's server is referenced, comparisons would not be between pages the user viewed and pages on the user's server, but between pages the user viewed and pages pulled by the user's server.

In embodiments, the predictions can also be ranked to the extent that the case base indicates a greater likelihood that one page would be viewed over another. For example, if everyone who visited pages A and B visited page E, but only 80% visited page F, then E could be considered a more confident prediction than F.

Also, which pages are predicted can be based upon the sequence in which the user viewed pages as well as which pages were viewed. For example, the predicted results might be different or ranked differently depending on whether the user visited pages ABCD in order, or whether the user visited the pages in the order DCBA. It would not be likely to change the pages that are predicted, but it could change the confidence in the predicted pages and change the effect the predicted pages have on the final search results.

Table 1 lists predicted pages from a server based upon a variety of user behaviors. Each sequence of pages leads to a likely prediction for the next page(s) the user will choose. For example, if during a particular time window, a user visits page P1 located on the server S1, pages P2, P3, and P4 may all be predicted based upon the servers case base. The pages P2, P3, and P4 may or may not be predicted with equal degrees of probability. If a user visits P2 and P3, page P4 is predicted. If the user visits P1, P2, and P3, then page P5 is predicted.

TABLE 1
Predicted Pages from a server based on user web history.

| Previously Visited Page | Predicted Next Page |
|---|---|
| P1 | P2, P3, P4 |
| P2, P3 | P4 |
| P1, P2, P3 | P5 |

After obtaining a list of predicted pages, compare the set of predicted pages with the search results and adjust the search results based upon the predicted pages. Those predicted pages that match pages in the search results could be ranked higher. How high the predicted pages would be ranked would depend upon the confidence in the predictability. Alternatively, the matching pages could be highlighted in some manner. Additionally, predicted pages that aren't part of the search results could be added to the search results as potential matches. Thus, collaborative filtering techniques would provide the user with contextualized search results.

Obviously, in a few cases the search results would not be adjusted. This could be for a variety of reasons including because no pages were predicted based upon the user's history or because the search results already include the predicted pages at the highest ranks, etc.

FIG. 2 is a flowchart illustrating the various aspects of the methods described herein. First a search is performed upon the user's request 110. The search results are then obtained 120. In embodiments, for each search result a case base for the corresponding server is either prepared or accessed 130. Also, a case base for the user's server is prepared 140. Step 130, 140, or both may be performed; however, both are not required. Next, a time window is defined 150, and the pages viewed by the user during the time window are determined 160. Either or both of these steps may be performed before, after, or simultaneously with steps 130 and 140. Then the pages viewed by the user are compared against the cases bases to generate a list of predicted pages 170. Next, compare the list of predicted pages with the search results 180. Finally, the search results are adjusted by reordering existing results, highlighting particular results, or possibly adding new results to the list.

Another method for personalizing a search would be to keep a history of the user's previous searches and use this search history to modify the search results. The device could rank results based upon the user's prior search interests and upon which pages the user went to from previous searches. For example, suppose a user had previously searched for gravity's rainbow and selected results that related to Thomas Pynchon and his novels. The results of a subsequent search for pynchon could be ranked so that results related to Thomas Pynchon are moved closer to the top or to the top of the list.

The “weight factor” used to modify the raw search results could be implemented in different manners. One possibility is to retain data from the search result pages the user has viewed recently. For example, repeated words or phrases or heading information may be retained. These may be cross-referenced against the results of the search and a high correlation of common words and phrases could be used to adjust the rank of the search results. Also pages that linked to the pages viewed by the user could be made part of a case base for the user profile. Other criteria from the page may be used as well. The weight factor could also weight the results according to what terms had been previously searched and the frequency with which those terms had been searched.

Further, the user's results could also be based upon the search or viewing history of others who use the search engine. The machine hosting the search engine or another device connected to the machine hosting the search engine could process data from previous searches and the behavior of previous searchers to weight the data. Specifically, for example, the pages viewed by previous searchers could be recorded and analyzed for a finite period of time. Commonly viewed pages of previous users could be kept. For example, the computer processor used to analyze the data could determine that users who selected pages A, B, and C from a set of search results also viewed page D. When a new user performs a search, and pages A, B, and C came up, page D could be added to or ranked higher in the results. Also correlations between the user's own search history and others who were interested in similar topics could be made. For example say the current user had viewed pages A, B, and C previously while using the search engine and that users who selected pages A, B, and C from a set of search results also typically viewed page D. If D was among the results of a search for the user, it's ranking could be adjusted. Also, correlations between result pages and search terms could be made. For example, perhaps searchers who used the terms “homer” and “simpson” in their searches frequently visited the Simpson's Archive on the web. If this were the case, the archive could be ranked higher, highlighted, or otherwise adjusted in the search results. This kind of analysis and processing could be run in the background either continuously or periodically.

The user's search history could be kept locally on the user's computer; for example, the user's search history could be written to a cookie stored on the user's site. Alternatively, the user's search history could be stored remotely on the server or device hosting the search engine. The user's history could be tracked for the user's current session of web activity, the past few days, the past few weeks, or longer. Where the user's search history is stored in a cookie locally, the cookie can be updated each time the user uses the search engine. Where the user's search history is stored on the server or device hosting the search engine, it may be desirable to have the user login to a system to use the search engine and associate the search history information with a user profile stored for that user.

FIG. 3 is a flowchart illustrating the various aspects of the methods described herein. First a search is performed upon the user's request 210. The search results are then obtained 220. Next the results are compared with the user's search history 230. The results are then adjusted based upon the user's search history 240. Adjusting includes reordering, highlighting, or adding to results. Also, the results can be compared with the general search history of those who used the search engine 250. The search results are then adjusted based upon the general search history 260. Steps 230 and 250 may both take place before steps 240 and 260.

The claims, as originally presented and as they may be amended, encompass variations, alternatives, modifications, improvements, equivalents, and substantial equivalents of the embodiments and teachings disclosed herein, including those that are presently unforeseen or unappreciated, and that, for example, may arise from applicants/patentees and others.

1. A method, comprising:
receiving a search request;
performing a traditional web query that returns a set of result pages;
using collaborative filtering techniques to generate a set of predicted pages;
comparing the set of predicted pages with the set of result pages; and
adjusting the set of result pages based upon the set of predicted pages.

2. The method of claim 1, wherein each of the set of result pages comes from a server, and wherein using collaborative filtering techniques includes obtaining a case base for at least one of the servers from which a result page came.

3. The method of claim 2, wherein obtaining a case base includes generating the case base.

4. The method of claim 2, wherein obtaining a case base includes accessing the case base.

5. The method of claim 2, wherein using collaborative filtering techniques to generate a set of predicted pages includes:
generating a list of viewed pages visited by a source of the request within a finite time period before the search; and
comparing the list of viewed pages with the case base for the at least one server to generate a list of predicted matches.

6. The method of claim 5, wherein the finite time period is a predetermined value.

7. The method of claim 5, wherein the finite time period is received from the source of the search request.

8. The method of claim 1, wherein using collaborative filtering techniques includes obtaining a case base for the server from which the web query originated.

9. The method of claim 8, wherein using collaborative filtering techniques to generate a set of predicted pages includes:
generating a list of viewed pages visited by a source of the request within a finite time period before the search; and
comparing the list of viewed pages with the case base for the server from which the web query originated.

10. The method of claim 1, wherein adjusting the set of result pages includes ranking the set of result pages so that result pages that are also included in the set of predicted pages are ranked higher than they would have been otherwise.

11. The method of claim 1, wherein adjusting the set of result pages includes highlighting any of the result pages that are the same as the predicted pages.

12. The method of claim 1, wherein adjusting the set of result pages includes adding predicted pages that aren't part of the result pages to the search results as potential matches.

13. A method for performing a search of the web, comprising:
receiving a search request;
performing a traditional web query that returns a set of result pages;
defining a time period prior to the search;
determining what pages were visited by the source of the search request during the time period prior to the search.
adjusting the set of result pages based upon the set of viewed pages.

14. The method of claim 13, wherein the finite time period is a predetermined value.

15. The method of claim 13, wherein the finite time period is received from the source of the search request.

16. A method for personalizing a web search, comprising:
retaining a record of a user's search history; and
adjusting the results of the web search in view of the user's search history.

17. The method of claim 16, further comprising retaining information on pages that link to at least one page in the user's search history.

18. The method of claim 16, wherein retaining a record of a user's search history includes writing the user's search history to a cookie on a computer with which the user connects to the web.

19. The method of claim 16, wherein retaining a record of a user's search history includes storing the history in a database remote from the user.

20. The method of claim 16, further comprising comparing the user's search history with the search history of other user's to determine a set of predicted pages, and wherein the predicted pages are used to adjust the results of the web search.

21. The method of claim 16, wherein the results come are listed in a particular order and where adjusting the results includes reranking the set of result pages in view of the user's search history.

22. A method for personalizing a web search, comprising:
retaining a record of previous searches conducted by the search engine;
determining a set of predicted pages for particular search terms based upon the record of previous searches; and
adjusting the results of the web search by the predicted pages.
